(19) United States
(12) Patent Application Publication
(10) Pub. No.: US 2016/0286734 A1
(43) Pub. Date: Oct. 6, 2016

(54) Method for adjusting and stabilizing a support for a plant

(71) Applicant: Robert Deeb, Averill Park, NY (US)

(72) Inventor: Robert Deeb, Averill Park, NY (US)

(21) Appl. No.: 15/160,504

(22) Filed: May 20, 2016

Related U.S. Application Data
(62) Division of application No. 13/684,575, filed on Nov. 26, 2012.

(51) Int. Cl. A01G 9/12; A01G 17/04; A01G 1/00

(52) U.S. Cl. CPC A01G 9/122; A01G 1/001; A01G 17/04; A01G 9/128

(57) ABSTRACT

This disclosure shows a method for adjusting and stabilizing a support for a plant by using the steps of winding or wrapping straps around the stems of vine plants or other types of plants to support growth of the plants and then affixing male and female snap connectors embedded on the said straps to male and female snap connectors embedded into a stake or to male and female snap connectors embedded on the said straps or embedded onto another of said straps. The purpose of the method is to accommodate plant growth and to maintain a vertical growth pattern for the vine or other type of plant.

This application is a Divisional application of prior non-provisional application Ser. No. 13/684,575 and claims the benefit of prior non-provisional application Ser. No. 13/684,575 the entire content of which is hereby incorporated herein by reference

### Cross-Reference to Related Applications

Ser. No. 13/684,575

### STATEMENT REGARDING FEDERALLY SPONSORED RESEARCH OR DEVELOPMENT

Not Applicable

### BACKGROUND

This invention relates to the support of plants, and in particular vine plants, in their growth from seedling to mature plant. Various support methods have been used to support plant material as it grows and bears fruit or vegetables. Many tomato plant growers, and those involved in growing vine plants in general, seek to ensure that these plants grow in a vertical direction in a controlled pattern of growth. Without a vertical support structure the tomato plant and other vine plants will grow as much horizontally as vertically or in several directions simultaneously. This is undesirable if the grower wants to maximize tomato or other vine plant yield, ensure sunlight access or to avoid predation by insects. There are several different support methods that have been patented. They typically involve various mechanisms whose main purpose is to assist the vertical growth of the vine plants. These support structures usually involve metal or other materially constructed rods in a cage type or lattice type or geometrical configuration. These structures are usually rigid to a large degree and entail multiple threading and interweaving of the vine plant through the support mechanism. This can lead to a complicated attachment mechanism between the plant and the support structure which can increase the risk of damage to the vine plant from adjustment by people growing the plants. For these reasons, there is a need for a method that is simple to use, flexible and uncomplicated.

### SUMMARY

This invention relates generally to gardening accessories and more particularly concerns supports for long stemmed plants such as tomato plants and the like.

The invention comprises flexible binding straps onto which are embedded or inserted snap-fit assemblies. These flexible binding straps are wound or wrapped around the plant stem and then snapped onto reciprocating snap-fit assemblies through the means of interconnecting male and female portions that connect in a mating fashion with one snap connector having a protrusion and the other having a hollow, where one connector snaps into another connector on opposing snap-fit assemblies or snap connectors on other straps. Snap-fit assemblies are placed at varying points along the length of the rod or stake to allow for adjustment of the support straps at different points along the plant stem. In the alternative, it is possible to use other connecting mechanisms to connect the binding straps together.

This present method is a simple and effective way to provide support to growing vine plants and the like in order to protect these plants and to maximize their yield potential. One of the objects of this invention is to provide an improved plant support. This invention may also be applicable to any vine type plant where people want to control the path or direction of growth that the plant undertakes. This method aims to eliminate complexity in plant support mechanisms by simplifying the parts used for the support structure and to provide for flexibility in the support method so as to be able to respond to the growing plant. Work in installing and maintaining plant supports will be reduced. The method will take less time, will be easier to use and be straightforward so as to avoid damaging the plants when making height adjustments to the support apparatus.

The method, including rod or stake and flexible straps can be manufactured from any flexible materials, for instance, cloth type material.

### DRAWINGS

These and other features, aspects, and advantages of the present invention will become better understood with regard to the following description, appended claims, and accompanying drawings where:

FIG. 1 shows a flexible strap, with male and female snap connectors attached to each other.

FIG. 2 is a close-up view of a strap with male and female snap attachments connected or joined onto each other to form a loop at one end.

FIG. 3 is a perspective view which shows the apparatus in use supporting a vine plant and attached to a rod or stake placed in the ground.

FIG. 4 shows an example of a rod or stake that might be used in the process of supporting a plant.

FIG. 5 Shows close-up or view of rod or stake that might be used in the process of supporting a plant

### REFERENCE NUMERALS

100—snap-connector (either male or female)

100a—female snap-connector

100b—male snap-connector

101—strap

102—rod or stake

103—portion of rod or stake fixed into ground

104—close up of stake

105—depiction of the method of adjusting and stabilizing an adjustable plant support

### DESCRIPTION

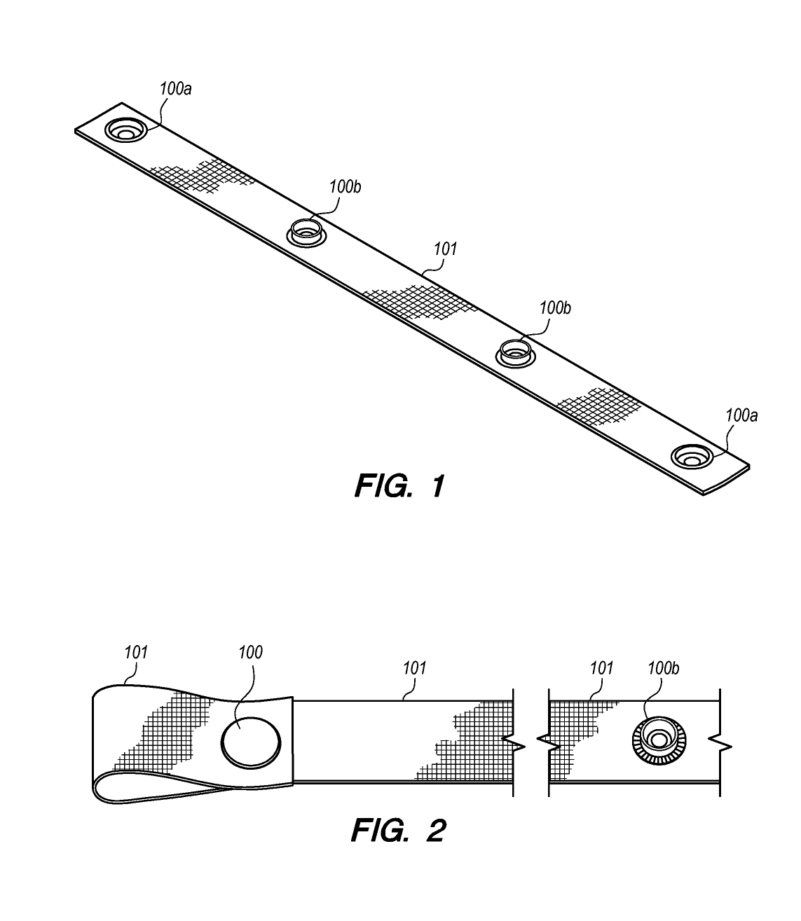

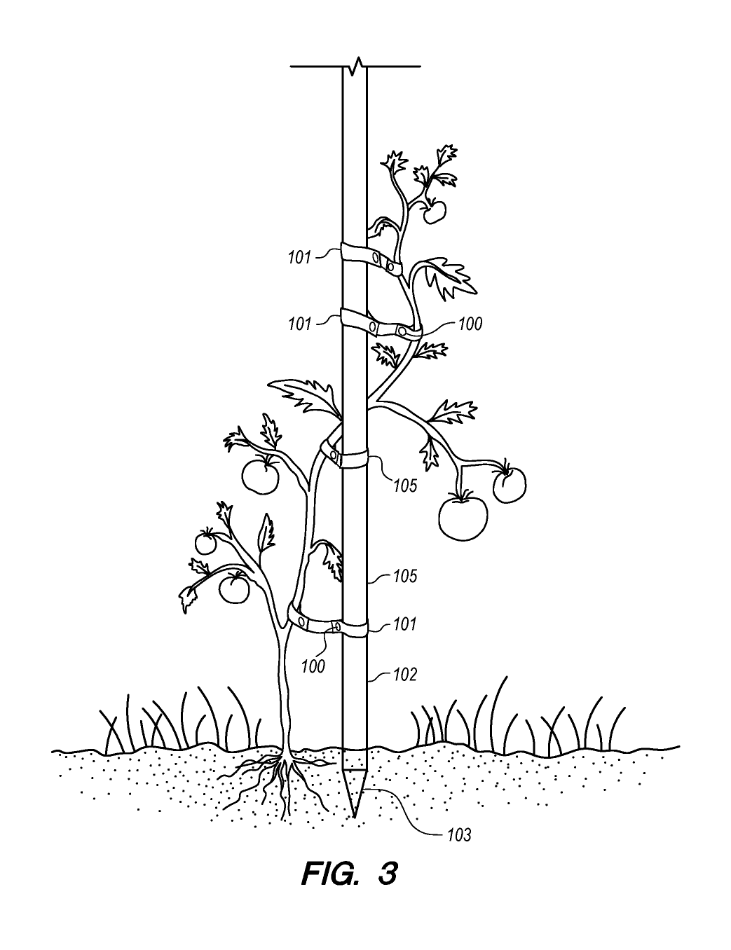

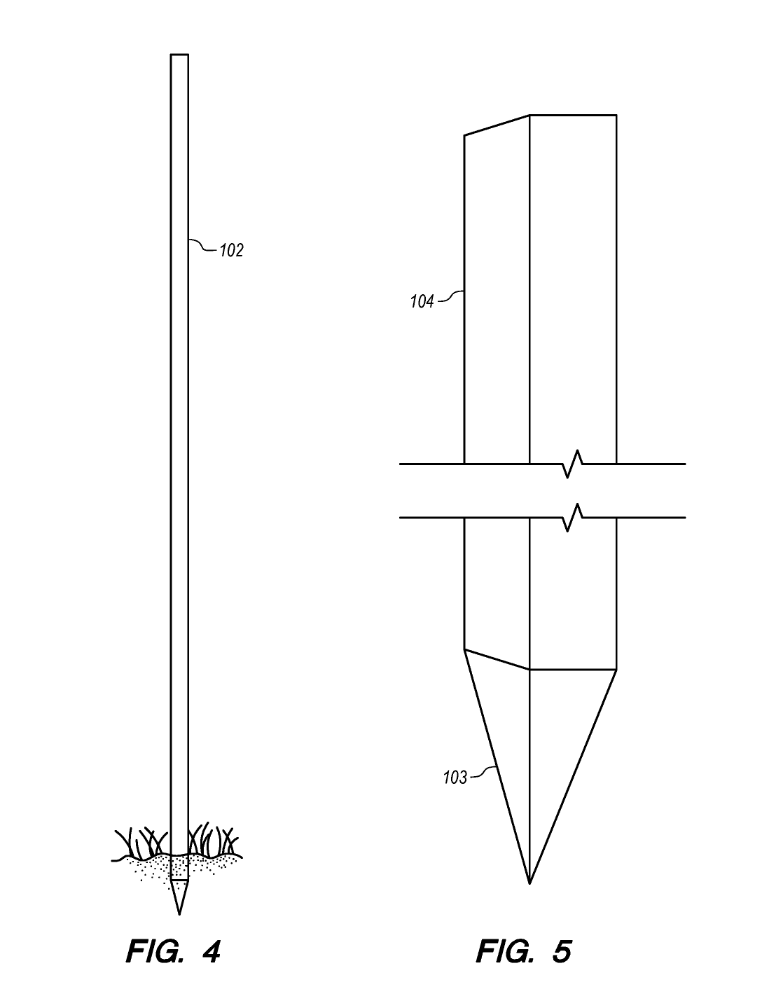

Referring to the drawings, there is illustrated a method for use of an adjustable plant support FIG. 1, FIG. 2, FIG. 3, FIG. 4 and FIG. 5 in accordance with the invention providing for universal adjustability.

This is a method FIGS. 1, 2 and 3 that allows a person working with plants, particularly vine plants, to adjust the height of the support structure for the plant to allow for the vertical growth of the plant and to accommodate the limbs and branches of the plant as they grow.

In one embodiment, the method FIGS. 1 and 2 comprises the use of metal, preferably stainless steel, or perhaps plastic male and female reciprocating snap connectors 100b and 100a or other suitable material, attachments or fasteners manufactured to a commercial grade or acceptable quality which are embedded in flexible straps 101 and which said straps 101 are wrapped around tomato plants or other vine plants. The snap connectors 100 connect through the means of interconnecting male 100b and female 100a portions that connect in a mating fashion with one snap connector having a protrusion and the other having a hollow, where one connector snaps into another connector on the same strap only or onto connectors on other straps. In other words, the snap connectors can comprise snap-fit button assemblies 100 that connect together by using reciprocating male 100b and female 100a connecting portions. The said snap connectors 100 embedded on the flexible straps 101 are then snapped or secured into place on another reciprocating snap connector 100 on the same flexible strap or different flexible strap 101. The snap connectors 100 include those that are commercially available such as snap-fit button assemblies in any of the variations that such snap-fit button assemblies variously take. The flexible straps can be made from any fabric or materials that allows for adjustment to the strap.

A plant support rod or stake 102 and FIG. 4 which can have a four sided square shape 104 FIG. 5 along the longitudinal axis and which square shape is one inch in length on all sides when observed longitudinally is provided containing at least five pairs of equidistantly spaced male or female snap connectors 100 placed on two opposite sides of the plant support rod or stake 102 at fixed stationary positions and onto which the male or female snap connectors 100, which are embedded in the said flexible straps 101, can be affixed or attached and secured into place at the varying points along the plant support rod or stake 102 at the positions at which the male or female snap attachments 100 are placed along the plant support rod or stake 102 to accommodate plant growth and to maintain a vertical growth path for the vine plant. The rod or stake 102 can also be round in cross section or any other convenient shape and can comprise any variation in number of fastening notches or male or female snap connectors.

The said plant support rod or stake 102 can be made out of a hard plastic material or other durable, weather resistant material substitutes. One end of the plant support rod or stake 102 is tapered to a sharp point or tip and is made from or capped with a metal or other durable, hard surfaced rust protected material 103. This tapered point end 103 of the plant support rod or stake is to be placed into the ground to provide a foundation for the plant support rod or stake 102 and can have a metal cap or cap made from other durable, hard surfaced rust protected material. The length of the plant support rod or stake 102 is typically 72 inches but can vary in length.

In one embodiment, FIGS. 1 and 2, the said flexible straps 101 will have typically four snap connectors 100 embedded in each flexible strap 101. These snap connectors 100 will be equidistantly placed two at each opposite end of each flexible strap 101. Alternatively, there may be more than four snap connectors 100 on the said flexible straps 101. The said flexible straps 101 can be made from any durable, flexible material that will enable the straps 101 to be easily pliable and which can be readily wrapped around the stem of a vine plant or any other plant. Such materials may be cloth fabric based, for example. The straps 101 can be made into varying overall lengths such as 12 inches, 16 inches or 18 inches so as to allow for adjustment that permits the user of the user of this method of use of the apparatus to loosely wrap the flexible strap 101 around the plant without causing damage to the plant and permitting also the natural growth of the plant without any other impediment. Each male or female snap connector on the said flexible straps 101 can then be interchangeably attached, fastened or secured into place onto any other snap connector 100 on the flexible straps 101 or on the said plant support rod or stake 102 FIG. 3 securing in place the flexible straps 101 onto the chosen fixed points on the plant support rod or stake 102.

Another embodiment of the adjustable plant support apparatus 105 would include the option to snap each end of a strap 101 using the male and female snap connectors embedded on the said strap 101 onto each other around a rod or stake 102 without attaching the strap 101 to the rod or stake 102/104 as illustrated in FIG. 3. This gives the user the option to buy just the straps 101.

It is not necessary for all embodiments of the invention to have all the advantages of the invention or fulfill all the purposes of the method.

Where reference is made herein to a method comprising two or more defined steps, the defined steps can be carried out in any order or simultaneously (except where the context excludes that possibility), and the method can include one or more other steps, which are carried out before any of the defined steps, between two of the defined steps, or after all the defined steps (except where the context excludes that possibility).

What is claimed is:

1-16. (canceled)

17. A method for adjusting and stabilizing a support for a plant, the method comprising:
(a) winding or wrapping straps around the stems of vine plants or other types of plants to support growth of the plants,
(b) affixing male and female snap connectors embedded on the said straps to male and female snap connectors embedded on a stake or to male and female snap connectors embedded on the said straps or embedded onto another of said straps.

18. The method for adjusting and stabilizing a plant support as defined in claim 17 wherein said male and female snap connectors are made from metal, stainless steel, or plastic or other suitable material.

19. The method for adjusting and stabilizing a plant support as defined in claim 17 wherein said male and female snap connectors connect in a mating fashion.

20. The method for adjusting and stabilizing a plant support as defined in claim 17 wherein the rod or stake comprises at least five pairs of equidistantly spaced male or female snap connectors.

21. The method for adjusting and stabilizing a plant support as defined in claim 17 wherein the rod or stake has a metal tip on the end that is driven into the ground and a metal cap on the opposite end.

22. The method for adjusting and stabilizing a plant support as defined in claim 17 wherein the rod or stake is four sided and is a square in cross section with a dimension length of one inch on each side.

23. The method for adjusting and stabilizing a plant support as defined in claim 17 wherein the shaft of the rod or stake is manufactured from plastic, wood or fiber glass.

24. The method for adjusting and stabilizing a plant support as defined in claim 17 wherein the straps are made from cloth or plastic or other flexible material.
